(19) United States
(12) Patent Application Publication
(10) Pub. No.: US 2018/0295271 A1
(43) Pub. Date: Oct. 11, 2018

(54) REMOTE MONITORING METHOD, APPARATUS, AND SYSTEM, USING SMART PHONE

(71) Applicant: JOEUN SAFE CO., LTD., Seoul (KR)

(72) Inventor: San KIM, Seoul (KR)

(73) Assignee: JOEUN SAFE CO., LTD., Seoul (KR)

(21) Appl. No.: 15/765,271

(22) PCT Filed: Oct. 20, 2015
(86) PCT No.: PCT/KR2015/011060

§ 371 Date: Apr. 2, 2018

(30) Foreign Application Priority Data
Oct. 12, 2015 (KR) 10-2015-0141959

(51) Int. Cl. H04N 5/232; H04N 7/18

(52) U.S. Cl. CPC H04N 5/23206; H04N 5/23261; H04N 5/23296; H04N 7/185

(57) ABSTRACT

A remote monitoring method includes the steps of: (c) receiving a control data for changing an image area captured by the smart phone from a communication channel, which transmits and receives data through an Internet, by the smart phone; (d) controlling a cradle through a short-range network using a pan/tilt control data for controlling one or more of pan and tilt of the cradle, on which the smart phone is mounted, using the received control data, by the smart phone; and (e) encoding an image captured through a provided camera module and outputting the encoded image through the Internet, after controlling the cradle, by the smart phone.

### TECHNICAL FIELD

The present invention relates to a remote monitoring method, apparatus and system using a smart phone, and more specifically, to a remote monitoring method, apparatus and system using a smart phone, which can remotely monitor an image from a smart phone using a camera module provided in the smart phone and extend the area of the monitored image by controlling the cradle of the smart phone.

### BACKGROUND ART

Closed circuit TeleVison (CCTV) are known. The CCTV is a system including a surveillance camera and a surveillance server so that an image captured by the surveillance camera may be transmitted to the surveillance server. The CCTV can be applied in various fields such as industry, home, traffic monitoring, disaster prevention and the like.

The surveillance camera of the CCTV is provided with a special camera only for image monitoring, the special camera may have a pan, tilt and zoom function. Since the remote surveillance server may connect to the pan, tilt and zoom (PTZ) camera from a remote site and control the corresponding camera, it can monitor remote images from various angles of view.

The application fields of CCTV may be expanded, and a CCTV system can be widely utilized at home. For example, the CCTV system may be used for the purpose of monitoring infants, old people and pet animals at home where the infants, old people and pet animals live.

Like this, the application fields of CCTV tend to expand to new applications for household purposes, beyond the existing industrial and traffic monitoring purposes.

Meanwhile, with the advancement in communication and software techniques, smart phones are widely used. The smart phones are provided with an application processor (AP) and may execute various functions other than communication functions. To execute the various functions, the smart phones are provided with various components. For example, the smart phones are provided with a camera module, a gyro sensor, an LCD module, a vibration sensor, an internal memory, a SD memory and the like.

In addition, due to rapid expansion and short repurchase cycles of the smart phones, idle smart phones increase, and particularly, unused smart phones tend to increase at home or the like. As described above, since the smart phones are provided with camera modules on the front and rear sides and may store and drive application software such as Apps in the internal memory, they can be used as an element of the CCTV system.

An invention entitled “Important facility monitoring system using smart phone” (Korean Patent Registration No. 10-1425598, publicized on Aug. 4, 2014) is known. This is an invention for monitoring important facilities using a smart phone and discloses that a smart phone is installed in a cradle and the angle of view of a monitoring image can be extended as the smart phone controls the cradle. In addition, a terminal for a nearby worker of this invention is configured to connect to a smart phone in a cradle through a short-range communication and control the smart phone.

Although this invention may adjust the position of the smart phone through the cradle in an aspect, there is a problem in that a monitoring area is not easy to adjust in real-time while monitoring an image. Particularly, it is not easy to remotely control a monitoring area and output an image through Internet communication with other smart phones which desire to monitor the area.

Furthermore, when an image area of a smart phone is remotely controlled through the Internet communication, it may need to easily grasp a current monitoring image area of the smart phone, which is an element of the CCTV system.

Like this, a remote monitoring method, apparatus and system using a smart phone is needed to solve the various problems arising as the smart phones are applied to a CCTV, while configuring the CCTV system using the smart phones.

### DISCLOSURE OF INVENTION

### Technical Problem

Therefore, the present invention has been made in view of the above problems, and it is an object of the present invention to provide a remote monitoring method, apparatus and system using a smart phone, which can control and accordingly extend an image area photographed by the smart phone by controlling the cradle of the smart phone in real-time, while configuring a CCTV system using the smart phone.

Another object of the present invention is to provide a remote monitoring method, apparatus and system using a smart phone, which can determine a current monitoring image area of the smart phone of a CCTV system and a monitoring image area changed in real-time owing to tilt and pan control using a sensor provided in the smart phone.

Another object of the present invention is to provide a remote monitoring method, apparatus and system using a smart phone, which can control drive of pan and tilt motors of a cradle using a control data received through the Internet and accurately control pan and tilt by confirming a sensor value of a corresponding smart phone.

Another object of the present invention is to provide a remote monitoring method, apparatus and system using a smart phone, which can dynamically store, when an emergency situation is sensed using an app program provided in the smart phone, a corresponding image of the sensed emergency situation in the memory of the smart phone.

The technical problems to be solved by the present invention are not limited to those mentioned above, and unmentioned other technical problems may be clearly understood by those skilled in the art from the following descriptions.

### Technical Solution

To accomplish the above objects, according to one aspect of the present invention, there is provided a remote monitoring method using a smart phone, the method comprising the steps of: (c) receiving a control data for changing an image area captured by the smart phone from a communication channel, which transmits and receives data through an Internet, by the smart phone; (d) controlling a cradle through a short-range network using a pan/tilt control data for controlling one or more of pan and tilt of the cradle, on which the smart phone is mounted, using the received control data, by the smart phone; and (e) encoding an image captured through a provided camera module and outputting the encoded image through the Internet, after controlling the cradle, by the smart phone.

In addition, to accomplish the above objects, there is provided a remote monitoring apparatus using a smart phone, the apparatus comprising: a cradle; and the smart phone mounted on the cradle, and the smart phone includes: a communication interface for transmitting and receiving communication packets of a communication channel, which can receive a control data for changing an image area captured by the smart phone, through an Internet; a processor for controlling the cradle through a short-range network using a pan/tilt control data for controlling one or more of pan and tilt of the cradle using the control data received through the communication interface; and a camera module for capturing an image under the control of the processor, wherein the processor encodes the image captured through the camera module after controlling the cradle and outputs the encoded image to a monitoring terminal through the communication interface.

In addition, to accomplish the above objects, there is provided a remote monitoring system using a smart phone, the system comprising a smart phone mounted on a cradle, and the smart phone includes: a communication interface for transmitting and receiving communication packets of a communication channel, which can receive a control data for changing an image area captured by the smart phone, through an Internet; a processor for controlling the cradle through a short-range network using a pan/tilt control data for controlling one or more of pan and tilt of the cradle using the control data received through the communication interface; and a camera module for capturing an image under the control of the processor, wherein the processor encodes the image captured through the camera module after controlling the cradle and outputs the encoded image to a monitoring terminal through the communication interface.

### Advantageous Effects

The remote monitoring method, apparatus and system using a smart phone according to the present invention as described above has an effect of controlling and accordingly extending an image area photographed by the smart phone by controlling the cradle of the smart phone in real-time, while configuring a CCTV system using the smart phone.

In addition, the remote monitoring method, apparatus and system using a smart phone according to the present invention as described above has an effect of determining a current monitoring image area of the smart phone of a CCTV system and a monitored image area changed in real-time owing to tilt and pan control using a sensor provided in the smart phone.

In addition, the remote monitoring method, apparatus and system using a smart phone according to the present invention as described above has an effect of controlling drive of pan and tilt motors of a cradle using a control data received through the Internet and accurately controlling pan and tilt by confirming a sensor value of a corresponding smart phone.

In addition, the remote monitoring method, apparatus and system using a smart phone according to the present invention as described above has an effect of dynamically storing, when an emergency situation is sensed using an app program provided in the smart phone, a corresponding image of the sensed emergency situation in the memory of the smart phone.

The effects that can be obtained from the present invention are not limited to those mentioned above, and unmentioned other effects may be clearly understood by those skilled in the art from the following descriptions.

### BRIEF DESCRIPTION OF THE DRAWINGS

FIG. 1 is a block diagram showing an example of a remote monitoring system using a smart phone.

FIG. 2 is a block diagram showing an example of a smart phone included in a remote monitoring system as an element.

FIG. 3 is a block diagram showing an example of a cradle.

FIG. 4 is a view showing a process of mapping a driving control data and a corresponding movement position when a smart phone is initially installed in a remote monitoring system.

FIG. 5 is a view showing an example process of controlling an image area photographed by a smart phone from a remote site using a mapping relation.

### BEST MODE FOR CARRYING OUT THE INVENTION

The objects, features and advantages described above may be further clear through the detailed description described below in detail with reference to the accompanying drawings. Accordingly, those skilled in the art may easily embody the spirit of the present invention. In addition, in describing the present invention, when it is determined that the detailed description of the known art related to the present invention may obscure the gist of the present invention, the detailed description thereof will be omitted. Hereinafter, the preferred embodiments of the present invention will be hereafter described in detail with reference to the accompanying drawings.

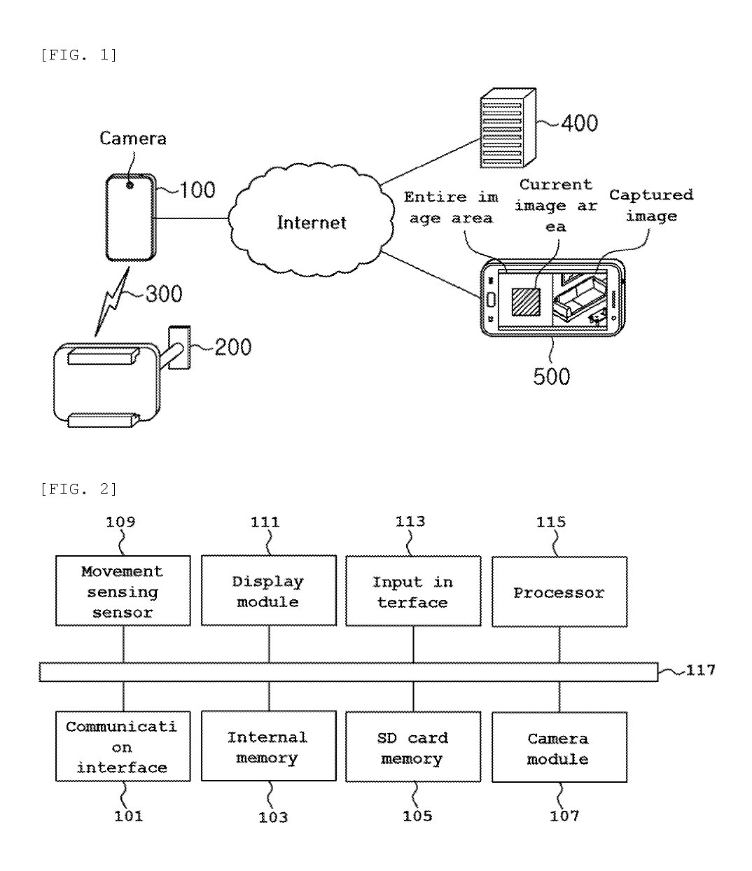

FIG. 1 is a block diagram showing an example of a remote monitoring system using a smart phone 100.

According to FIG. 1, a remote monitoring system includes a smart phone 100, a cradle 200 for mounting (or resting) the smart phone 100, a management server 400 for controlling and/or managing the smart phone 100 through the Internet, and a monitoring terminal 500 capable of confirming an image captured by the smart phone 100 and changing an area of the captured image. Here, the cradle 200 may be referred to or recognized as a rest. In addition, the cradle 200 and the corresponding smart phone 100 forms a remote monitoring apparatus. The remote monitoring apparatus is configured to perform known pan and tilt functions using a camera module 107 of the smart phone 100 and pan and tilt motors 207 and 209 of the cradle 200.

The remote monitoring system may be configured in various forms according to application forms. For example, a specific system may include a plurality of smart phones 100 and a plurality of corresponding cradles 200.

Briefly describing each terminal or the like of the remote monitoring system, the smart phone 100 is provided with at least a communication interface 101, a processor 115 and a camera module 107 and may output an image captured through the camera module 107 through the communication interface 101.

The smart phone 100 may connect to a short-range network 300 such as Wi-Fi, Bluetooth, USB or the like, as well as a mobile communication network, and transmit and receive various kinds of data through the short-range network 300. The smart phone 100 used for image capturing in the remote monitoring system may be connected to various apparatuses or devices preferably using the short-range network 300. The smart phone 100 may be connected to the cradle 200 through the short-range network 300 and connected to the Internet via the short-range network 300.

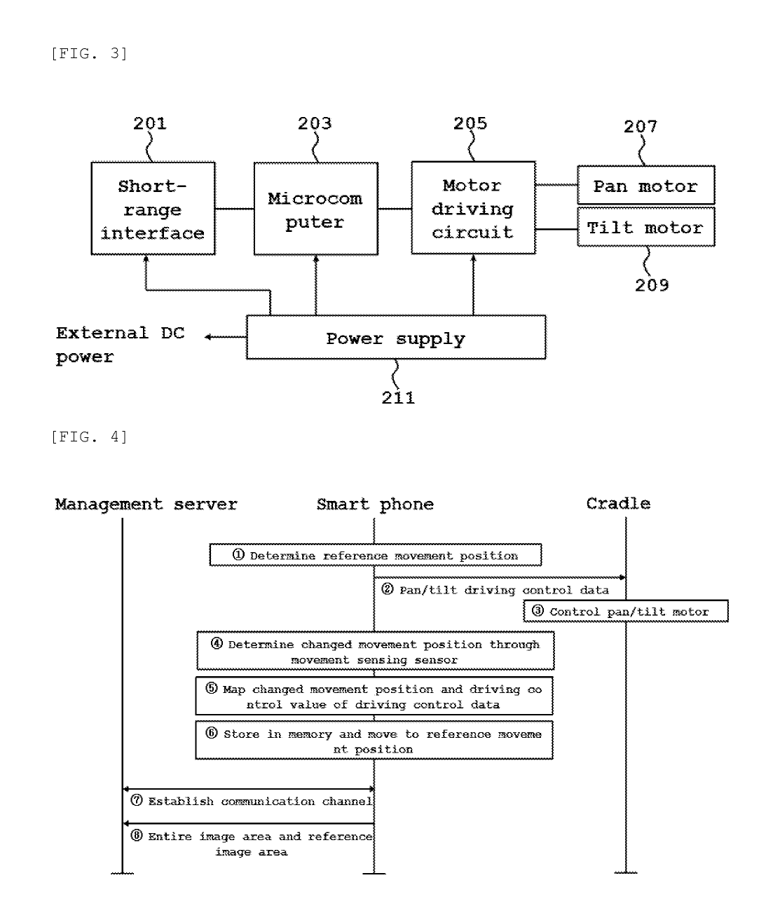

The smart phone 100 will be described in further detail through FIGS. 2, 4 and 5.

The cradle 200 is a device for mounting (resting) the smart phone 100. The cradle 200 is provided with a fixing means for fixing the smart phone 100 and mounts and fixes the smart phone 100. The fixing means includes, for example, screws, latches and the like and fixes the smart phone 100 to the cradle 200. The fixing means may have a known arbitrary form.

The cradle 200 is preferably provided with a pan motor 207 and a tilt motor 209 and may rotate the mounted smart phone 100 in the horizontal direction through the pan motor 207 and rotate the smart phone 100 in the vertical direction through the tilt motor 209.

The cradle 200 is configured at least to receive data from the smart phone 100 through the short-range network 300. For example, the cradle 200 receives a control data for driving the motors from the smart phone 100 through the wireless short-range network 300 such as Wi-Fi, Bluetooth or the like and controls a provided motor according to the received control data.

Here, the short-range network 300 for transmitting and receiving data between the smart phone 100 and the cradle 200 may be, for example, a wireless short-range network 300 such as Wi-Fi, Bluetooth or the like or a wired short-range network 300 such as USB, RS232 or the like.

The cradle 200 may generate DC power from AC power and supply the DC power that can be used in the smart phone 100 through a USB cable or the like.

The cradle 200 will be described in further detail through FIGS. 3 to 5.

The monitoring terminal 500 is a terminal capable of monitoring an image captured by a specific smart phone 100 in the remote monitoring system. The monitoring terminal 500 may be, for example, a cellular phone, a smart phone, a tablet PC, a personal computer, a terminal including a monitor, or a special terminal only for connecting to a remote smart phone 100 according to the present invention.

The monitoring terminal 500 may connect to the management server 400 through a program provided to connect to the smart phone 100 and/or the management server 400 and request the management server 400 connection or control of a specific smart phone 100. Accordingly, the monitoring terminal 500 may receive an image captured by the specific smart phone 100 in the remote monitoring system and display the image. Furthermore, the monitoring terminal 500 may change an image area that a corresponding smart phone 300 is photographing.

The monitoring terminal 500 will be described in further detail through FIG. 5.

The management server 400 manages the remote monitoring system. The management server 400 may receive image data from the smart phones 100 installed in the system through the cradle 200 and store the image data or output the image data to a manager.

In addition, the management server 400 may authenticate the monitoring terminal 500, identify a smart phone 500 that the authenticated monitoring terminal 500 may connect to or receive an image, and intermediate connection to a corresponding smart phone 100.

The management server 400 may receive a data which expresses an emergency situation from the smart phone 100 mounted on the cradle 200. The data on the emergency situation may be generated by the smart phone 100 when, for example, a moving object such as a human being, a face of the human being, an animal or the like is recognized from a captured image. The smart phone 100 may encode the image captured from the time point of generating the emergency situation in accordance to a compression format and store the image in an internal memory 103, an SD card memory 105 or the like.

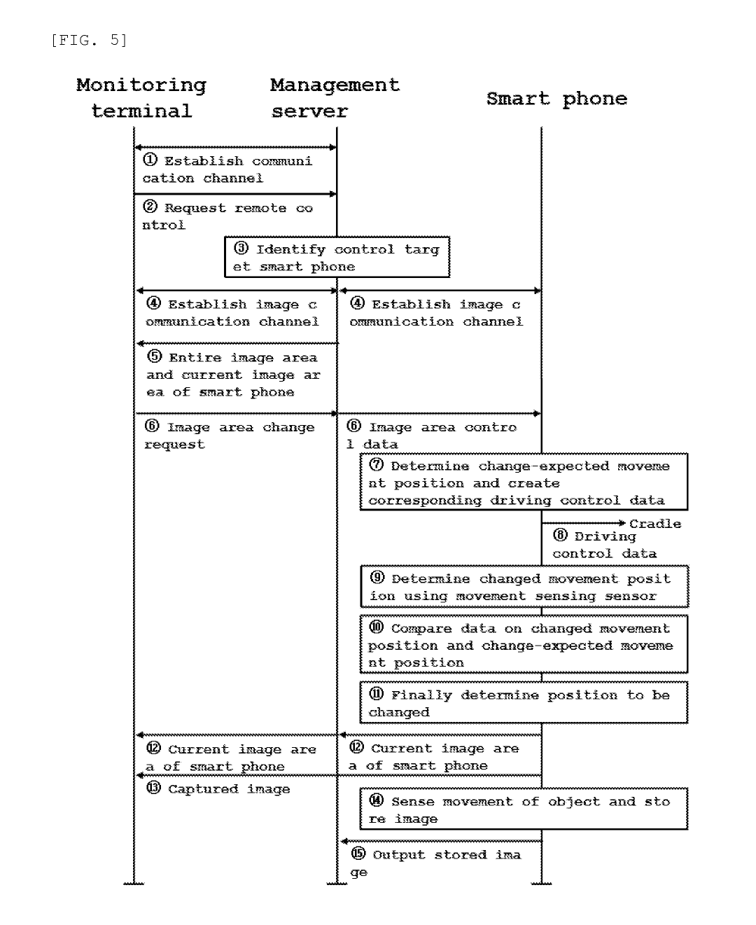

The management server 400 will be described in further detail through FIGS. 4 and 5.

FIG. 2 is a block diagram showing an example of a smart phone 100 included in a remote monitoring system as an element.

According to FIG. 2, the smart phone 100 includes a communication interface 101, an internal memory 103, an SD card memory 105, a camera module 107, a movement sensing sensor 109, a display module 111, an input interface 113, a processor 115 and a system bus/control bus 117. The block diagram of FIG. 2 preferably shows a hardware block diagram. Some of the blocks among the blocks of FIG. 2 may be omitted according to modified embodiments of the configuration. Or, other blocks may be further included in this block diagram.

Briefly describing each of the hardware blocks, the communication interface 101 is an interface for transmitting and receiving signals of communication packets through the short-range network 300. The communication interface 101 is provided with, for example, a Phy chipset and/or an antenna and may transmit and receive signals through a specific short-range network 300. The communication interface 101 may transmit and receive wireless signals conforming to, for example, Wi-Fi or Bluetooth standards or wired signals conforming to the standard of USB or the like.

The communication interface 101 may transfer the received communication packets to the processor 115 and transmit communication packets received from the processor 115 as a signal. For example, the communication interface 101 may receive communication packets representing a control data for changing an image area captured by the smart phone 100. The control data for changing an image area is received through a communication channel established together with the management server 400 or the monitoring terminal 500 on the Internet.

The internal memory 103 is a memory for storing various kinds of data and/or programs and is, for example, a volatile memory and/or a nonvolatile memory. The internal memory 103 may temporarily store captured images. For example, an encoded data of a captured image may be stored in the volatile memory or nonvolatile memory.

The internal memory 103 also stores application programs that can be executed by the processor 115. The application program (hereinafter, also referred to as a ‘monitoring program’) may control the cradle 200 in association with the management server 400 and/or the monitoring terminal 500 and encode and output the captured image to the management server 400 or the monitoring terminal 500 through the Internet. The application program may be a so-called App program. The application program may be mounted on the processor 115, and the processor 115 executes the application program.

The SD card memory 105 is a memory separable from the smart phone 100. The SD card memory 105 is a memory capable of extending the storage space of the internal memory 103. When an emergency situation occurs, the SD card memory 105 may store images captured thereafter.

The camera module 107 is provided with a lens and an image sensor and captures an image of a predetermined image area exposed through the lens. The camera module 107 captures an image in the image area under the control of the processor 115 and transfers data of the captured image to the processor 115. The camera module 107 may transfer an image data (signal) of a configured resolution to the processor 115 at regular intervals.

The movement sensing sensor 109 is a sensor capable of sensing movement of the smart phone 100. The movement sensing sensor 109 may be an acceleration sensor, a gyro sensor or the like. Preferably, the movement sensing sensor 109 may be a gyro sensor of three or more axes. The gyro sensor of three or more axes may acquire pitch, roll and yaw values. The pitch, roll and yaw values show changes in the orientation of the smart phone 100 on the X, Y and Z axes (space) where the smart phone 100 is positioned.

Particularly, the movement sensing sensor 109 shows changes in the orientation (directionality, direction) of the smart phone 100. The movement sensing sensor 109 makes it possible to specify an image area currently photographed or to be photographed in the entire image area that can be photographed in association with the pan and tilt motors 207 and 209 of the cradle 200. This will be described in detail through FIGS. 4 and 5.

The display module 111 outputs an image. The display module 111 includes, for example, an LCD or LED display. The display module 111 may output an image captured through the camera module 107 under the control of the processor 115.

The input interface 113 may receive a user input. The input interface 113 is provided with a user input means such as a touch panel, buttons or the like and may receive a user input requesting sensing an emergency situation in the remote monitoring system, a user input for setting a position of reference movement, or the like. The user input is transferred to the processor 115.

The processor 115 controls the blocks of the smart phone 100. The processor 115 is provided with one or more execution units capable of executing command codes of a program, executes a loaded program, and controls each of the blocks according to execution of the program.

For example, the processor 115 may perform various functions according to the present invention by loading a monitoring program stored in the internal memory 103 or the like onto an internal cache or a volatile memory in response to a user input or a monitoring request received through the management server 400 and executing the corresponding monitoring program. The processor 115 is referred to or represented as a so-called application processor (AP).

Various controls performed by the processor 115 will be described in further detail through FIGS. 4 and 5.

The system bus/control bus 117 transmits and receives data between the blocks. The system bus/control bus 117 includes a parallel bus, a serial bus, a General Purpose Input Output (GPIO) and the like. The system bus/control bus 117 may transmit and receive data or control data transferred between the blocks. Preferably, data are transmitted and received through the system bus/control bus 117 under the control of the processor 115. In addition, bus types or control types of the system bus/control bus 117 may be different from each other according to the types of the blocks.

FIG. 3 is a block diagram showing an example of a cradle 200.

According to FIG. 3, the cradle 200 includes a short-range interface 201, a microcomputer 203, a motor driving circuit 205, a pan motor 207 and a tilt motor 209 and further includes a power supply 211. The block diagram of FIG. 3 preferably shows a hardware block diagram. Some of the blocks among the blocks of FIG. 3 may be omitted or integrated according to modified embodiments of the configuration. For example, the pan motor 207 and the tilt motor 209 may be integrated as one motor according to modification of design. Or, other blocks may be further included in this block diagram.

Briefly describing each of the hardware blocks, the short-range interface 201 is an interface connected to the short-range network 300 to perform short-range communication with the smart phone 100. The short-range interface 201 is, for example, a wired interface or a wireless interface. The short-range interface 201 may be USB, RS232 or the like of wired communication or Wi-Fi, Bluetooth, Zigbee or the like of wireless communication.

The short-range interface 201 includes logic for configuring communication packets of, for example, a data link layer and/or a physical layer of wired or wireless communication. Through the short-range interface 201, the cradle 200 may receive a pan/tilt driving control data for controlling the pan and tilt motors 207 and 209 from the smart phone 100 and transmit the control data to the microcomputer 203.

The microcomputer 203 controls each of the blocks of the cradle 200. The microcomputer 203 may execute, for example, command codes of 8 bits, 16 bits or 32 bits and control other blocks by executing a program stored in a nonvolatile memory internal or external to the microcomputer 203.

The microcomputer 203 receives the pan/tilt driving control data through the short-range interface 201 and drives the pan motor 207 and/or the tilt motor 209 according to the received pan/tilt driving control data. The received pan/tilt driving control data is a data requesting a specific motor to move (rotate) in a specific direction and includes or expresses, for example, a driving direction (horizontal and/or vertical direction) and a driving period (time) of a corresponding motor. The microcomputer 203 controls the motor driving circuit 205 according to the received pan/tilt driving control data. The driving period may be omitted, and the driving period may be calculated on the basis of the time of applying the pan/tilt driving control data (the time period between the starting time and the ending time).

The motor driving circuit 205 is connected to the microcomputer 203 and receives a pan and/or tilt control signal from the microcomputer 203, generates a driving signal for driving the pan motor 207 and outputs the driving signal to the pan motor 207 and generates a driving signal for driving the tilt motor 209 and outputs the driving signal to the tilt motor 209, according to the pan and/or tilt control signal.

The outputted pan driving signal outputs a power signal for driving the pan motor 207, together with a driving direction signal of the pan motor 207. In addition, the outputted tilt driving signal outputs a power signal for driving the tilt motor 209, together with a driving direction signal of the tilt motor 209.

The pan motor 207 is a motor for moving (rotating) the cradle 200 in one axis (horizontal axis) direction. The pan motor 207 outputs power for moving the cradle 200 in one direction (e.g., toward the left side) or opposite direction (e.g., toward the right side) on a specific axis according to the pan driving signal outputted from the motor driving circuit 205. Accordingly, the cradle 200 may rotate left and right in a specified direction.

The tilt motor 209 is a motor for moving (rotating) the cradle 200 in one axis (vertical axis) direction. The tilt motor 209 outputs power for moving the cradle 200 in one direction (e.g., toward the bottom side) or opposite direction (e.g., toward the top side) on a specific axis according to the tilt driving signal outputted from the motor driving circuit 205. Accordingly, the cradle 200 may rotate up and down in a specified direction.

The cradle 200 may rotate up, down, left and right from the center points of the motors (e.g., the center points of two rotation axes of the cradle 200) by the pan motor 207 and the tilt motor 209. Accordingly, as the smart phone 100 mounted on the cradle 200 may also rotate, an image area captured through the smart phone 100 (e.g., an image area according to change of the direction of the position of the camera module 107 of the smart phone 100 or according to change of the center position of the smart phone 100) can be changed.

The power supply 211 supplies power to the cradle 200. The power supply 211 receives AC power through a power cable, generates one or more DC powers and/or AC powers from the AC power, and outputs the generated DC and/or AC powers to the blocks.

One of the output powers may be outputted to the motor driving circuit 205 and used for driving the pan motor 207 or the tilt motor 209, and the other powers may be outputted to the microcomputer 203. In addition, an outputted specific DC power may be supplied to the smart phone 100. For example, a DC power of 3.3V or 5V generated through the power supply 211 may be supplied to the smart phone 100. For example, the outputted 5V DC power may be supplied to the smart phone 100 through a power line of USB.

In addition, the cradle 200 is provided with a fixing means for fixing the smart phone 100 and mounts and fixes the smart phone 100. The fixing means includes, for example, screws, latches, brackets or the like and fixes the smart phone 100 to the cradle 200. The fixing means may have a known arbitrary form.

FIG. 4 is a view showing a process of mapping a driving control data and a corresponding movement position when a smart phone 100 is initially installed in a remote monitoring system.

In order to use the image of the smart phone 100 in the remote monitoring system, first, the smart phone 100 is mounted on the cradle 200 by the fixing means of the cradle 200 and installed in a specific environment. For example, the cradle 200 is fixedly installed on a wall in a space in which a monitoring target area exists, and the smart phone 100 is fixed to photograph a specific area in the space. The fixed installation is accomplished by a manager or an installer who manages the remote monitoring system. The smart phone 100 may perform this process using a provided monitoring program or the like.

Then, (the processor 115 of) the smart phone 100 performs a process of mapping a pan/tilt driving control data for driving the pan motor 207 and/or the tilt motor 209 and a movement position that can be changed using the movement sensing sensor 109 of the smart phone 100 (see \textcircled{1} to \textcircled{5}). Through the mapping process, the processor 115 of the smart phone 100 may confirm the entire image area which can rotate by using the cradle 200, and a specific movement position value may be mapped to a specific image area.

Describing the mapping process in more detail, an initial image area to be captured (photographed) by the smart phone 100 is set according to the fixed installation. This image area may be recognized as a reference image area, and the smart phone 100 determines a reference movement position corresponding to the reference image area through an input of the manager (the input interface 113) or the like (see \textcircled{1}).

To determine the reference movement position, the processor 115 of the smart phone 100 determines a movement position of the smart phone 100 from the movement sensing sensor 109 after the user's input for setting the reference image area. For example, the processor 115 determines position (coordinate) values of three axes (e.g., pitch, roll and yaw values) corresponding to the reference image area as the reference movement position and stores the position values in the internal memory 103 or the SD card memory 105 after matching (mapping) the position values and the reference movement position (reference image area).

Then, the processor 115 outputs a pan/tilt driving control data for moving the cradle 200 in a rotation direction on one of the pan and tilt axes to the cradle 200 through the short-range network 300 (see \textcircled{2}). The outputted pan/tilt driving control data is, for example, a pan driving control data, which is a control data for driving the pan motor 207 to the left side.

As the pan/tilt driving control data is received through the short-range network 300, the microcomputer 203 of the cradle 200 outputs a control signal to the motor driving circuit 205 to control the pan/tilt motor 207 or 209 (see \textcircled{3}). For example, the microcomputer 203 outputs a control signal for driving the pan motor 207 to the left side to the motor driving circuit 205, and accordingly, the pan motor 207 is driven, and the cradle 200 may rotate to the left side. The pan/tilt driving control data may explicitly include a driving period, or the driving period may be recognized from the time of applying the driving control data. The driving period set in this process may be a period including the maximum rotatable range of the motor.

Rotation of a corresponding motor begins under the control of the pan/tilt motor 207 or 209. During the rotation process, the processor 115 of the smart phone 100 determines movement positions changing in correspondence to the movement sensing data outputted from the movement sensing sensor 109 using the movement sensing sensor 109 at regular intervals (e.g., 0.05 seconds, 0.1 seconds or the like) (see \textcircled{4}). That is, while the driving control data is applied, data on the position values (e.g., pitch, roll and yaw values) of the three axes of the movement sensing sensor 109 is determined according to a predetermined interval.

In addition, the processor 115 maps each of the changed movement positions to a driving control value determined from the driving control data outputted or being outputted (see \textcircled{5}). For example, the processor 115 maps the position values of the three axes to the identifiers of the pan/tilt motors 207 and 209, direction values on the axes of the pan/tilt motors 207 and 209, a driving time value corresponding to a corresponding position value (e.g., a time elapsed after the driving control data is outputted, or a value of the number of intervals).

If the cradle 200 goes out of the rotatable limit as the pan/tilt motors 207 and 209 rotate, the position value of the movement sensing sensor 109 may be within a threshold range in which it may be recognized that the position value is the same as before or there is no movement. If the cradle 200 goes out of the rotation limit, the mapping process in one direction on one axis may be completed.

Then, the processor 115 may control and move the pan/tilt motors 207 and 209 to the reference movement position to perform the mapping process in another direction (toward the right side) on the same axis (pan) and then performs the mapping process in another direction through the steps of \textcircled{2} to \textcircled{5}. In the same manner, the mapping process for bi-directional movement (toward top and bottom sides) on another axis (tilt) is performed from the reference movement position through the steps of \textcircled{2} to \textcircled{5}.

Through these processes, the processor 115 may determine the entire image area rotatable through the cradle 200 (e.g., a spread area including all the image areas according to the rotation). The entire image area is an expansion of an image area that can be captured by the camera module 107 and shows an area extendable using the pan motor 207 and the tilt motor 209. The entire image area may be expressed as a two-dimensional coordinate system, and an image area of the camera module 107 also can be expressed in a coordinate system within the entire image area.

The processor 115 of the smart phone 100 stores the mapped driving control value and a corresponding movement position in the memory respectively and also stores the reference movement position (see \textcircled{6}). In addition, the processor 115 rotates the smart phone 100 to the reference movement position using the position value (may be referred to as a coordinate value or a movement value) received from the movement sensing sensor 109 (see \textcircled{6}). Rotation to the reference movement position is accomplished by controlling drive of the pan/tilt motors 207 and 209 so that a position value corresponding to the previously set reference movement position or a position value within the threshold range of this position value may be acquired from the movement sensing sensor 109.

In addition, the processor 115 maps a two-dimensional coordinate area expressing an image area corresponding to each movement position to each movement position and stores the mapped the coordinate area. Each image area is expressed as a coordinate area included in the entire image area. In addition, the processor 115 sets the reference movement position as a current movement position corresponding to an image area being captured currently and stores the current movement position. The current movement position may be set to the position values received from the movement sensing sensor 109 and set to, for example, pitch, roll and yaw values.

The mapping relation (mapping data) stored in the memory is used later to create a pan/tilt control data by the processor 115. Like this, the mapping data is used to control the cradle 200.

Then, the processor 115 of the smart phone 100 establishes a communication channel with the management server 400 through the communication interface 101 (see \textcircled{7}). This communication channel is a channel for transmitting and receiving control data and/or captured images to and from the management server 400 through the Internet. This communication channel is configured as a security channel and may be encrypted as needed.

As the communication channel is established, the smart phone 100 outputs data expressing the entire image area that can be monitored by the smart phone 100 connected to the cradle 200 (e.g., a two-dimensional coordinate range) and a reference image area currently monitored according to the reference movement position to the management server 400 through the communication channel (see \textcircled{8}).

Information (data) on the entire image area and the reference image area may be used later to change the image area of the smart phone 100 through the monitoring terminal 500.

FIG. 5 is a view showing an example process of controlling an image area photographed by a smart phone 100 from a remote site using a mapping relation.

The processing steps of FIG. 5 are performed after the mapping process of FIG. 4 is completed. Accordingly, a communication channel is established in advance between the smart phone 100 and the management server 400.

The monitoring terminal 500 for monitoring an image at a remote site through the smart phone 100 establishes a communication channel with the management server 400 (see \textcircled{1}). In the process of establishing the communication channel, the monitoring terminal 500 may log into the management server 400, and the management server 400 authenticates the monitoring terminal 500 using a password, a personal authentication key or the like. Authentication of the monitoring terminal 500 represents authentication of the terminal itself or authentication of a user of the monitoring terminal 500.

According to the authentication of the monitoring terminal 500, the management server 400 may provide the monitoring terminal 500 with a web page or the like that a user may access. The web page may include, for example, a selection list of cameras that can be accessed or controlled by the user of a corresponding monitoring terminal 500. A specific surveillance camera of the selection list may be a camera configured of the camera module 107 of the smart phone 100.

The user browses the selection list and requests the management server 400 remote control of a specific smart phone 100 (a smart phone 100 recognized as a surveillance camera) through the monitoring terminal 500 (see \textcircled{2}).

In response to the remote control request, the management server 400 identifies a control target smart phone 100, which has been requested to control in the monitoring system, using an internal database or the like (see \textcircled{3}). In this process, the management server 400 may also identify a communication channel connected to the smart phone 100 through the Internet. The management server 400 may manage the smart phone 100 through the communication channel connected through the Internet.

As the control target smart phone 100 is identified, the management server 400 establishes a communication channel for transmitting and receiving data between the monitoring terminal 500 that has requested the control and the identified smart phone 100 through the Internet (see \textcircled{4}).

The communication channel established between the monitoring terminal 500 and the smart phone 100 may be a communication channel connected by way of the management server 400 or a communication channel capable of transmitting and receiving data between the monitoring terminal 500 and the smart phone 100 without passing through the management server 400. Although data can be directly transmitted and received through a single communication channel through the Internet, preferably, a communication channel for images and a communication channel for control are separated. Preferably, the image communication channel is directly established between the monitoring terminal 500 and the smart phone 100, and the control communication channel is configured to accomplish control of the smart phone by way of the management server 400. The control communication channel may be configured of communication channel setting (see \textcircled{1} of FIG. 5) and communication channel setting of FIG. 4 (see \textcircled{7} of FIG. 4).

The monitoring terminal 500 may receive an encoded image from the smart phone 100 through the established image communication channel, decode the encoded image, and output the decoded image through the display of the monitoring terminal 500.

Meanwhile, the management server 400 outputs information on the current image area captured by the smart phone 100 connected as the image communication channel is established and the entire image area that can be monitored by the smart phone 100 to the monitoring terminal 500 through the established communication channel (see \textcircled{5}).

The monitoring terminal 500 may output the image received from the established image communication channel through the display and output which image area is currently captured through the display using the entire image area and coordinate information on the current image area (e.g., a rectangular coordinate area).

The entire image area represents an area that can be monitored by a corresponding smart phone 100 through the pan/tilt motors 207 and 209, and the current image area represents a coordinate area of an image captured within the entire image area. Initially, the current image area may represent a reference image area corresponding to the reference movement position.

The user of the monitoring terminal 500 may change an image area to be monitored within the entire image area through an input means. For example, the user may select a current image area highlighted on the canvas of the entire image area, select change of the current image area to an area of another position, and request the monitoring terminal 500 to change the monitoring image area.

According to user's input, the monitoring terminal 500 creates a change request expressing change of an image area and outputs the created change request to the management server 400 through the established communication channel (see \textcircled{6}).

The change request transferred to the management server 400 is configured to identify the image area desired to be changed and includes a data expressing an absolute coordinate area within the entire image area or include a data expressing an offset from the current image area to the image area to be changed.

Like this, the management server 400 is configured to receive various kinds of control requests including change of an area from the monitoring terminal 500 and perform a process according to the control request.

The transferred image area change request may be first received by the management server 400 and outputted to the smart phone 100 as an image area control data of a promised form (see \textcircled{6}). Alternatively, the monitoring terminal 500 itself may output an image area control data of a form promised with the smart phone 100 to the smart phone 100.

Like this, the smart phone 100 receives control data from the management server 400 or the monitoring terminal 100. The control data received through the communication channel established through the Internet to change an image area includes a data expressing the image area to be changed. The control data of the image area to be changed expresses, for example, an absolute coordinate area or a relative offset from the current image area. The received control data is received as communication packets through the communication interface 101 of the smart phone 100.

Then, (the processor 115 of) the smart phone 100 creates a pan/tilt control data for controlling one or more of pan and tilt of the cradle 200 on which the smart phone 100 is mounted using the received control data and outputs the created pan/tilt control data to the short-range network through the communication interface 101 (see \textcircled{7} to \textcircled{11}). The pan/tilt control data is a data for controlling drive of the pan motor 207 and/or the tilt motor 209. Like this, the smart phone 100 may change an image area being captured by controlling the cradle 200.

Describing the process of changing an image area through the control of the cradle 200 in more detail, first, the processor 115 of the smart phone 100 determines a change-expected movement position corresponding to an image area to be changed on the basis of the received control data and creates a driving control data for changing the image area to this position (see \textcircled{7}).

The processor 115 determines a change-expected movement position from the received control data. The processor 115 set this change-expected movement position as movement position values corresponding to the image area to be changed from the received control data and stored in the memory. Alternatively, the processor 115 determines an image area to be changed using the offset value of the received control data and set the change-expected movement position as the movement position values corresponding to the image area to be changed and stored in the memory.

The processor 115 also creates a driving control data for rotating (moving) the cradle 200 from the current movement position to the change-expected movement position. The driving control data is configured of a control data for driving the pan motor 207 and/or a control data for driving the tilt motor 209. The driving control data of the pan motor 207 includes or expresses a rotation direction of the pan motor 207 and a driving time value in a corresponding direction.

The driving time value is calculated using the mapped data of pan and tilt. For example, the driving time value may be calculated as a difference between a driving time value corresponding to the change-expected movement position and a driving time value of the current movement position. Like this, the driving control data for controlling each of the motors includes or expresses data on a rotation direction and a motor driving time of the corresponding rotation direction. The rotation direction may also be extracted from the mapping data (a direction value on the axis of the motor).

Then, the processor 115 of the smart phone 100 transfers the created pan/tilt driving control data to the communication interface 101 to be outputted through the short-range network 300 (see \textcircled{8}).

As the pan/tilt driving control data is received, the microcomputer 203 of the cradle 200 controls the motor driving circuit 205 to control the pan motor 207 and/or the tilt motor 209 corresponding to the pan/tilt driving control data and drives the pan motor 207 and/or the tilt motor 209 in a predetermined direction for a predetermined driving time.

The outputted pan/tilt driving control data may be divided into a driving control data for the pan motor 207 and a driving control data for the tilt motor 209 and separately or simultaneously outputted. According to the simultaneously or separately received driving control data, the cradle 200 controls a corresponding motor 207 or 209.

During or after rotation of the motor, the processor 115 of the smart phone 100 determines a movement position changed according to rotation of the motor through the movement sensing sensor 109 (see \textcircled{9}). The changed movement position may be expressed as, for example, pitch, roll and yaw values.

Then, the processor 115 of the smart phone 100 compares the changed movement position and the change-expected movement position (see \textcircled{10}). Whether the smart phone 100 mounted on the cradle 200 is rotated to the correct direction and position may be determined by the comparison of the two positions.

If the difference between the values of the changed movement position and corresponding values of the change-expected movement position is smaller than a predetermined threshold value, the processor 115 finally determines the position to be moved (see \textcircled{11}). If the difference exceeds the threshold value, the processor 115 creates again the driving control data for rotating (moving) the cradle 200 from the changed movement position to the change-expected movement position and outputs the driving control data to the cradle 200. The processor 115 of the smart phone 100 may rotate the cradle 200 to a correct position through these processes. In addition, the mapping relation (data) may be tuned through these processes.

Then, the processor 115 of the smart phone 100 sets and stores the changed movement position measured by the movement sensing sensor 109 in the memories 103 and 105 as the current movement position and determines a current image area corresponding to the current movement position in the entire movement area using the mapped data. Information on the determined current image area is outputted to the management server 400 and/or the monitoring terminal 500 through the Internet (see \textcircled{12}).

In addition, the processor 115 of the smart phone 100 captures an image of the current image area through the camera module 107, encodes the captured image according to a predetermined compression format, and outputs the encoded image through the Internet (see \textcircled{13}). The outputted image is preferably outputted through the established image communication channel and transferred to the monitoring terminal 500.

The monitoring terminal 500 may decode the encoded image and output the decoded image through a provided display.

In addition, the processor 115 of the smart phone 100 senses movement of an object from the captured image (see \textcircled{14}). For example, the processor 115 may sense a movement larger than a preset threshold value using a movement vector or the like in the encoding process of a predetermined compression format. Alternatively, the processor 115 may recognize a person or a face from the image. When such a movement is sensed, the processor 115 stores the captured image in the memory of the smart phone 100 (see \textcircled{14}).

As a movement is sensed, a state expressing that a movement is sensed is outputted to the management server 400 of the smart phone 100, and the processor 115 of the smart phone 110 outputs an image stored in the memory to the management server 400 in response to an image transmission request received from the management server 400 (see \textcircled{15}).

Through the control flow as described above, image monitoring can be performed at a correct position measured by the smart phone 100, and change of an image area can be simply configured from a remote site through the Internet.

### INDUSTRIAL APPLICABILITY

Since those skilled in the art may make various substitutions, modifications and changes without departing from the scope and spirit of the invention, the present invention described above is not limited to the above embodiments and the accompanying drawings.

1. A remote monitoring method using a smart phone, the method comprising the steps of:
(c) receiving a control data for changing an image area captured by the smart phone from a communication channel, which transmits and receives data through an Internet, by the smart phone;
(d) controlling a cradle through a short-range network using a pan/tilt control data for controlling one or more of pan and tilt of the cradle, on which the smart phone is mounted, using the received control data, by the smart phone; and
(e) encoding an image captured through a provided camera module and outputting the encoded image through the Internet, after controlling the cradle, by the smart phone.

2. The method according to claim 1, wherein step (d) includes the steps of:
determining a change-expected movement position of the smart phone using the received control data;
outputting a driving control data for driving pan/tilt motors of the cradle through the short-range network;
determining a changed movement position using a movement sensing sensor provided in the smart phone; and
comparing data on the changed movement position and the change-expected movement position.

3. The method according to claim 2, wherein the short-range network is Wi-Fi or Bluetooth which are wireless short-range networks or a USB which is a wired short-range network.

4. The method according to claim 1, further comprising, before step (c), the step of (b) mapping a movement position that can be changed and a driving control data for driving pan/tilt motors of the cradle using a provided movement sensing sensor, by the smart phone.

5. The method according to claim 4, wherein step (b) includes the steps of:
determining a reference movement position using the movement sensing sensor;
outputting the driving control data of the pan/tilt motors of the cradle;
mapping movement positions changed according to the outputted driving control data to a driving control value determined from the driving control data; and
storing a plurality mapped driving control values and movement positions in a memory of the smart phone, wherein
the mapping data stored in the smart phone is used for creation of the pan/tilt control data of step (d).

6. The method according to claim 1, further comprising the steps of:
sensing movement of an object from the captured image, by the smart phone; and
storing, when movement of an object is sensed, the captured image in a memory of the smart phone, wherein
the stored image can be outputted to a management server connected through the Internet.

7. A remote monitoring system using a smart phone, the system comprising a smart phone mounted on a cradle, wherein the smart phone includes:
a communication interface for transmitting and receiving communication packets of a communication channel, which can receive a control data for changing an image area captured by the smart phone, through an Internet;
a processor for controlling the cradle through a short-range network using a pan/tilt control data for controlling one or more of pan and tilt of the cradle using the control data received through the communication interface; and
a camera module for capturing an image under the control of the processor, wherein
the processor encodes the image captured through the camera module after controlling the cradle and outputs the encoded image to a monitoring terminal through the communication interface.

8. The system according to claim 7, wherein to control the cradle using the pan/tilt control data, the processor determines a change-expected movement position of the smart phone using the received control data, outputs a driving control data for driving pan/tilt motors of the cradle through the short-range network, determines a changed movement position using a movement sensing sensor provided in the smart phone, and compares data on the changed movement position and the change-expected movement position.

9. The system according to claim 7, wherein the smart phone further includes a movement sensing sensor capable of sensing a movement, wherein the processor maps a movement position of the smart phone that can be changed and a driving control data for driving pan/tilt motors of the cradle using a movement sensing data outputted from the movement sensing sensor, and the smart phone controls movement of the cradle using the mapping relation.

10. The system according to claim 7, further comprising:
a monitoring terminal for monitoring the smart phone; and
a management server for managing the smart phone at a remote site through the Internet, wherein
the management server authenticates the monitoring terminal, identifies a smart phone in the monitoring system to which the monitoring terminal may connect, outputs a control data for controlling the cradle to the smart phone through the Internet in response to a control request received from the monitoring terminal, and establishes an image communication channel between the monitoring terminal and the identified smart phone, and the monitoring terminal receives the encoded image from the smart phone through the established image communication channel and outputs the encoded data through a display.

11. A remote monitoring apparatus using a smart phone, the apparatus comprising:
a cradle; and
the smart phone mounted on the cradle, wherein
the smart phone includes:
a communication interface for transmitting and receiving communication packets of a communication channel, which can receive a control data for changing an image area captured by the smart phone, through an Internet;
a processor for controlling the cradle through a short-range network using a pan/tilt control data for controlling one or more of pan and tilt of the cradle using the control data received through the communication interface; and
a camera module for capturing an image under the control of the processor, wherein
the processor encodes the image captured through the camera module after controlling the cradle and outputs the encoded image to a monitoring terminal through the communication interface.
